(19) United States
(12) Patent Application Publication
(10) Pub. No.: US 2018/0003626 A1
(43) Pub. Date: Jan. 4, 2018

(54) GAS CONCENTRATION MEASUREMENT APPARATUS

(71) Applicant: HORIBA, LTD., Kyoto-shi (JP)

(72) Inventors: Kimihiko ARIMOTO, Kyoto (JP); Issei YOKOYAMA, Kyoto (JP); Tomoko SEKO, Kyoto (JP); Yutaro TSUCHISAKA, Kyoto (JP); Daisuke KITAKI, Kyoto (JP); Yasuo FURUKAWA, Kyoto (JP)

(73) Assignee: HORIBA, LTD., Kyoto-shi (JP)

(21) Appl. No.: 15/616,077

(22) Filed: Jun. 7, 2017

(30) Foreign Application Priority Data
Jun. 30, 2016 (JP) 2016-130749
Jun. 30, 2016 (JP) 2016-130750

(51) Int. Cl. G01N 21/3504

(52) U.S. Cl. CPC G01N 21/3504; G01N 2291/0212

(57) ABSTRACT

In order to provide a gas concentration measurement apparatus that suppresses any change in the temperature of an optical fiber, and also makes it difficult for any effects to appear in the measurement accuracy due to air from the surrounding environment penetrating the optical path of the measurement light while using only a simple structure and without causing any excessive energy consumption there are provided a first sealing component provided between an incident surface of a gas cell and a first end surface that is formed at a periphery of an emission aperture of a light-emitting unit so as to enclose the periphery of the emission aperture, and a second sealing component provided between an emission surface of the gas cell and a second end surface that is formed at a periphery of an incident aperture of a light-receiving unit so as to enclose the periphery of the incident aperture.

### TECHNICAL FIELD

The present invention relates to a gas concentration measurement apparatus that introduces gas into a gas cell and also measures the concentration of this gas based on the absorptivity thereof.

### TECHNICAL BACKGROUND

For example, in a semiconductor manufacturing process, various liquid materials are gasified by being heated so as to form material gases, and these material gases are then introduced into a vacuum chamber where film formation on substrates is performed. In order to maintain the quality of the semiconductors being manufactured, it is necessary for the concentrations of the introduced material gases to be kept constant.

In order to perform this type of concentration control, a gas concentration measurement apparatus that measures the concentration of material gases based on an NIR method (i.e., on near infrared spectroscopy) is incorporated into the process.

One gas concentration measurement apparatus of this type (see Patent document 1) is a gas concentration measurement apparatus that is provided with a gas cell into which a material gas is introduced, a first optical fiber into one end of which measurement light emitted from a halogen light source is introduced and from another end of which the measurement light is emitted, a first lens that performs collimation on the measurement light emitted from the first optical fiber and then emits the measurement light into the gas cell, a second lens that condenses the measurement light that has been transmitted through the interior of the gas cell, and a second optical fiber into one end of which the measurement light condensed by the second lens is introduced and from another end of which the measurement light is emitted into a photodetector. The gas concentration is then calculated from the absorbance of light of a predetermined wavelength measured by the photodetector, and a calibration curve that has been prepared in advance and shows a relationship between the concentration and the absorbance for various types of gases.

In order to prevent a material gas cooling inside the gas cell and becoming reliquefied, and consequently affecting the concentration measurement, it is necessary to heat the gas cell itself. However, the temperature changes generated by this heat also cause the light-guiding characteristics of the respective optical fibers provided adjacent to the gas cell to change, and the effects of this appear in the measured absorbance. In some cases, this causes the accuracy of the concentration measurement to deteriorate.

In order to solve this type of problem, consideration might be given to providing a gap so as to separate the holders respectively holding each optical fiber and each lens from the gas cell, so as to make if difficult for the heat used to heat the gas cell to be conducted via the respective holders to the respective optical fibers.

However, if gaps are provided between the respective holders and the gas cell, then there is a possibility that air from the surrounding environment will flow in through these gaps and penetrate the optical path of the measurement light so that the absorbance of the measurement light will be affected by gases other than the material gas. Moreover, when the gas cell is heated by a heater mechanism so that reliquefaction of a sample gas is prevented, then because the temperature of the lens is lower than that of the surrounding air which has been heated by the heater mechanism, condensation ends up being formed on the lens and this changes the characteristics of the optical system. Having said that, if the entire gas concentration measurement apparatus is covered by a case in an attempt to keep the temperature of the air in the surrounding environment constant, then mutually opposing forms of control, namely, control to heat the gas cell and control to cool the respective holders need to be performed simultaneously. As a result, energy is wasted in the system as a whole.

### DOCUMENTS OF THE PRIOR ART

### Patent Documents

[Patent document 1] Japanese Unexamined Patent Application (JP-A) Laid-Open No. H6-94609

### DISCLOSURE OF THE INVENTION

### Problems to be Solved by the Invention

The present invention was therefore conceived with the intention of solving all of the above-described problems, and it is an object thereof to provide a gas concentration measurement apparatus that suppresses any change in the temperature of an optical fiber, and also makes it difficult for any effects to appear in the measurement accuracy due to air from the surrounding environment penetrating the optical path of the measurement light while using only a simple structure and without causing any excessive energy consumption.

The present invention was conceived in view of the above-described problems and it is a further object thereof to provide a gas concentration measurement apparatus that is able to prevent reliquefaction by maintaining a sample gas inside a gas cell at a high temperature, and makes it difficult for heat to be conducted to an optical fiber that is used to emit or receive measurement light, and that, as a consequence, suppresses any change in the light-guiding characteristics of the gas concentration measurement apparatus.

### Means for Solving the Problem

Namely, a gas concentration measurement apparatus according to the present invention is provided with a gas cell equipped with an incident surface through which measurement light is irradiated into an interior of the gas cell, and an emission surface through which the measurement light is emitted to the outside of the gas cell, and that is formed such that a sample gas is introduced into the interior of the gas cell, a heater mechanism that heats the gas cell, a light-emitting unit that causes measurement light that has been emitted from an end surface of a first optical fiber provided inside the light-emitting unit to be emitted into the gas cell via an emission aperture, a light-receiving unit that causes measurement light that has passed through the gas cell and is to be irradiated into an incident aperture to be irradiated onto an end surface of a second optical fiber provided inside the light-receiving unit, a first sealing component that is provided between the incident surface of the gas cell and a first end surface that is formed at a periphery of the emission aperture of the light-emitting unit so as to enclose the periphery of the emission aperture, and a second sealing component that is provided between the emission surface of the gas cell and a second end surface that is formed at a periphery of the incident aperture of the light-receiving unit so as to enclose the periphery of the incident aperture.

If this type of structure is employed, then because the light-emitting unit and the light-receiving unit are not formed integrally with the gas cell, but are separated therefrom, even if the gas cell is heated by the heater mechanism in order to prevent reliquification of the sample gas, it becomes difficult for this heat to be conducted to the first optical fiber and the second optical fiber. Accordingly, it is also difficult for temperature changes to occur in the first optical fiber and the second optical fiber, and the light-guiding characteristics thereof can be kept substantially constant.

Furthermore, air from the surrounding environment or other gases are prevented from penetrating the emission aperture or the incident aperture by the first sealing component and the second sealing component. Accordingly, it is possible to prevent errors in the measured absorbance that are caused by gases other than the sample gas circulating on the optical path of the measurement light from occurring. Furthermore, because there is no penetration by air and the like from the surrounding environment that has been warmed by the heater mechanism, air and the like from the surrounding environment does not become condensed on low-temperature components forming the light-emitting unit and the light-receiving unit and consequently cause moisture to form, so that any changes in the optical system can be prevented from occurring.

Because of these advantages, it is possible to maintain a high level of accuracy when measuring gas concentrations while using only a simple structure and without causing any excessive energy consumption.

In order to reduce the conduction of heat from the gas cell to the light-emitting unit and the light-receiving unit via the first sealing component and the second sealing component, and to thereby make it possible to further prevent any change in the temperature of the first optical fiber and the second optical fiber, and maintain a high level of accuracy when measuring gas concentrations, it is also possible for the first sealing component and the second sealing component to be formed by O-rings. These O-rings may be formed, for example, from resin, or they may be formed from metal.

In order to ensure that the light-emitting unit and the light-receiving unit do not come into direct contact with the gas cell, and in order to substantially limit the heat conduction path from the gas cell to being a path that goes via the first sealing component and the second sealing component so that there are no changes in the temperature of the first optical fiber and the second optical fiber, it is desirable that, in a state in which the first sealing component and the second sealing component have been provided, a first gap be formed between the incident surface of the gas cell and the first end surface of the light-emitting unit, and a second gap be formed between the emission surface of the gas cell and the second end surface of the light-receiving unit.

In order to ensure that the first sealing component and the second sealing component are compressed so that air and the like from the surrounding environment can be reliably prevented from penetrating the emission aperture and the incident aperture, at the same time as heat conduction from the gas cell to the light-emitting unit and the light receiving unit is prevented, it is also possible for the first gap and the second gap to be substantially the same size, and for a thickness dimension prior to deformation of each of the first sealing component and the second sealing component to be set so as to be larger than the first gap and the second gap.

Even if the sample gas is, for example, a gas that is highly reactive with metal such as H₂O₂, in order to suppress such reactions and prevent the concentration measurement being affected, and to also make it easier to prevent heat from being conducted to the first optical fiber and the second optical fiber, it is also possible for the gas cell to be formed from quartz glass, and for the light-emitting unit to be provided with a first optical fiber via whose end surface measurement light is emitted, a first lens that performs collimation on the measurement light emitted from the end surface of the first optical fiber, and a first holder that is made from resin and inside which are held the first optical fiber and the first lens, and for the first aperture and the first end surface to be formed in the first holder, and for the light-receiving unit to be provided with a second optical fiber via whose end surface measurement light is introduced, a second lens that condenses measurement light onto the end surface of the second optical fiber, and a second holder that is made from resin and inside which are held the second optical fiber and the second lens, and for the second aperture and the second end surface to be formed in the second holder.

In order to ensure that the heater mechanism only heats the gas cell, and that heat is prevented from being conducted directly to the light-emitting unit and the light-receiving unit, it is also possible for the heater mechanism to be a jacket heater that is wrapped around the periphery of the gas cell, and is provided so as to be separated from the first end surface and the second end surface.

In order to enable the light-emitting unit and the light-receiving unit to be arranged symmetrically to each other centering on the gas cell, and to be placed naturally in positions that correspond with the design values so as to prevent discrepancies from being generated in the optical system, it is also possible for there to be further provided a fixing mechanism that fixes the first end surface of the light-emitting unit and the second end surface of the light-receiving unit such that these are a predetermined distance apart from each other, and a temporary holding mechanism that temporarily holds the gas cell such that the gas cell is able to slide in the direction of the optical axis of the measurement light, and for a structure to be employed in which the gas cell is gripped between the light-emitting unit and the light-receiving unit by being pressed by repulsive force from the first sealing component and the second sealing component.

An example of a specific structure in which the gas concentration measurement apparatus according to the present invention is favorably used is a structure in which the sample gas introduced into the gas cell contains H₂O₂, and the measurement light contains light in a near infrared region, and there is further provided a concentration calculator that calculates the concentration of the H₂O₂ introduced into the gas cell interior based on the absorbance of the measurement light received by the light-receiving unit.

Namely, the gas concentration measurement apparatus according to the present invention includes a gas cell equipped with a cell main body into whose interior sample gas is introduced, an incident portion through which measurement light is irradiated into an interior of the cell main body, and an emission portion through which the measurement light that has passed through the cell main body is emitted to the outside, and the gas concentration measurement apparatus also includes a heater mechanism that heats the gas cell, or the sample gas introduced into the gas cell, a first optical fiber that is provided so as to emit measurement light from an end surface thereof, and cause this measurement light to be irradiated into the incident portion, and a second optical fiber that is provided such that the measurement light that has passed through the emission portion is irradiated onto an end surface of the second optical fiber. In this case, the incident portion and the emission portion have a double-glazed window structure whose interior is either maintained in a vacuum, or holds a gas.

If this type of structure is employed, then because the incident portion and the emission portion have a double-glazed window structure, even if heating is performed by the heater mechanism in order to prevent the sample gas from becoming reliquefied, it becomes difficult for this heat to be conducted to the first optical fiber and the second optical fiber due to the thermal insulation effect provided by the double-glazed window structure. Accordingly, it is also difficult for temperature changes to occur in the first optical fiber and the second optical fiber, and the light-guiding characteristics thereof can be kept substantially constant.

Furthermore, because it is possible to prevent the first optical fiber and the second optical fiber from being affected by heat simply by providing the double-glazed window structures of the incident portion and the emission portion, the heater mechanism can be provided directly in the gas cell without a two-fold structure, in which an inner side wall and an outer side wall are provided in the cell main body, having to be formed in order to prevent heat from the cell main body being transmitted to the outside. Accordingly, a sample gas circulating inside the gas cell can be heated efficiently and reliquefaction can be reliably prevented.

Because of these advantages, it is possible to maintain a high level of accuracy when measuring gas concentrations while using only a simple structure and without causing any excessive energy consumption.

In order to make it easy for the optical path of measurement light inside a gas cell to remain essentially the same as in a conventional gas cell that does not have a double-glazed window structure, and to make it possible to improve the accuracy of gas concentration measurement, it is also possible for the double-glazed window structure to include an inner window plate that is attached to the cell main body, an outer window plate that is provided at a predetermined distance from the inner window plate so as to be parallel with the inner window plate, and an enclosing wall that connects the inner window plate to the outer window plate so as to form a closed space, and for an interior of the closed space to be either maintained in a vacuum, or to hold a gas.

In order to improve assemblability and make it easy to form an optical path from the first optical fiber to the second optical fiber even if discrepancies are generated in the overall configuration as a result of double-glazed window structures being formed in the incident portion and the emission portion, and to ensure that the fixing process does not place a heavy load on the gas cell itself so that the lifespan of the product can be extended, it is also possible to provide the cell main body with an elongated shape, and to join the incident portion and the emission portion respectively to a mutually different end portion of the cell main body, and to further provide a supporting mechanism that supports one point of a central portion of the cell main body.

In order to make it easy to attach the heater mechanism uniformly to the interior of the cell main body so as to make it possible to uniformly heat the sample gas inside the cell main body, it is also possible to provide the cell main body with an elongated shape, and to join the incident portion and the emission portion respectively to a mutually different end portion of the cell main body, and to further provide supporting mechanisms that support both ends of the gas cell at the incident portion and the emission portion. If this type of structure is employed, then the gas cell can be stably supported, and the heater mechanism can be provided in the cell main body, and it is possible to avoid a situation in which components that might obstruct the interior temperature of the cell being more uniformly and stably increased are installed.

Furthermore, in order to make it easier for a sample gas to be provided evenly throughout the cell main body, and to make it more difficult for an uneven temperature distribution to occur in the sample gas circulating through the gas cell interior, it is also possible for the heater mechanism to be a jacket heater that is wrapped around the cell main body.

In order to ensure that an equivalent mechanical strength and an equivalent dimensional tolerance in the gas cell, as well as equivalent light transmission characteristics for measurement light as those that can be obtained conventionally can still be easily achieved even if a double-glazed window structure is formed, it is also possible for the gas cell to be formed from a plurality of quartz glass pieces, and for the incident portion and the emission portion to be bonded via optical contact bonding to the cell main body. Moreover, if this type of structure is employed, then even if the sample gas is one having a high degree of reactivity to metal, it is still possible to prevent any changes from occurring in the sample gas.

In order to make it difficult for problems to occur such as, for example, the optical characteristics being changed due to air from the surrounding environment that has been warmed by the heater mechanism subsequently cooling and forming condensation on the first optical fiber and the second optical fiber or on optical components adjacent thereto, it is also possible for there to be further provided a light-emitting unit that causes measurement light that has been emitted from an end surface of the first optical fiber provided inside the light-emitting unit to be emitted into the gas cell via an emission aperture, a light-receiving unit that causes measurement light that has passed through the gas cell and is to be irradiated into an incident aperture to be irradiated onto an end surface of a second optical fiber provided inside the light-receiving unit, a first sealing component that is provided between an incident surface, which is a surface on the incident portion that measurement light first strikes from an outer side, and a first end surface that is formed at a periphery of the emission aperture of the light-emitting unit, so as to enclose the periphery of the emission aperture, and a second sealing component that is provided between an emission surface, which is a surface on the emission portion that measurement light is ultimately emitted from, and a second end surface that is formed at a periphery of the incident aperture of the light-receiving unit, so as to enclose the periphery of the incident aperture.

In order to ensure that the heater mechanism only heats the gas cell, and that heat is prevented from being conducted directly to the light-emitting unit and the light-receiving unit, it is also possible for the heater mechanism to be a jacket heater that is wrapped around the periphery of the gas cell, and is provided so as to be separated from the first end surface and the second end surface.

An example of a specific structure in which the gas concentration measurement apparatus according to the present invention is favorably used is a structure in which the gas introduced into the gas cell contains H₂O₂, and the measurement light contains light in a near infrared region, and there is further provided a concentration calculator that calculates the concentration of the H₂O₂ introduced into the gas cell interior based on the absorbance of the measurement light received by the light-receiving unit.

### Effects of the Invention

In this way, according to the gas concentration measurement apparatus according to the present invention, even if the gas cell is being heated, there is substantially no conduction of this heat to the respective optical fibers, and an environment in which it is difficult for changes to occur in the light-guiding characteristics of these optical fibers can be created. Moreover, because the first sealing component and the second sealing component prevent air from the surrounding environment from penetrating the peripheries of the incident aperture and the emission aperture, it is possible to prevent the effects of light absorption from gases other than the sample gas, as well as the condensation of air from the surrounding environment from reducing the accuracy of a gas concentration measurement. Moreover, even if the components formed, for example, from resin and the like that make up the gas concentration measurement apparatus are partially vaporized by heat emitted by the heater mechanism, this vaporized gas can be prevented from penetrating the emission aperture and the incident aperture.

Moreover, according to the gas concentration measurement apparatus according to the present invention, even if the gas cell is being heated, the double-glazed window structure makes it possible to ensure that there is substantially no conduction of this heat to the respective optical fibers, and an environment in which it is difficult for changes to occur in the light-guiding characteristics can be created. Furthermore, it is possible to ensure that the sample gas is directly heated by the heater mechanism in the cell main body, and reliquefaction of the sample gas within the cell main body can be reliably prevented.

### BRIEF DESCRIPTION OF THE DRAWINGS

FIG. 1 is a typical view showing a gas concentration measurement apparatus and a gas concentration control system according to a first embodiment of the present invention.

FIG. 2 is a typical view showing the structure of the gas concentration measurement apparatus according to the first embodiment.

FIG. 3 is a typical perspective view showing the structures of a gas cell according to the first embodiment and of instruments adjacent thereto.

FIG. 4 is a typical front view showing the structures of the gas cell according to the first embodiment and of instruments adjacent thereto.

FIG. 5 is a typical cross-sectional view showing an internal structure of a light-emitting unit according to the first embodiment, and a positional relationship thereof relative to the gas cell.

FIG. 6 is a typical cross-sectional view showing an internal structure of a light-receiving unit according to the first embodiment, and a positional relationship thereof relative to the gas cell.

FIG. 7 is a typical perspective view showing the structures of a gas cell according to a second embodiment of the present invention and of instruments adjacent thereto.

FIG. 8 is a typical front view showing the structures of the gas cell according to the second embodiment and of instruments adjacent thereto.

FIG. 9 is a typical cross-sectional view showing a structure in the vicinity of an incident side of a gas cell according to the second embodiment.

FIG. 10 is a typical cross-sectional view showing a structure in the vicinity of an emission side of a gas cell according to the second embodiment.

FIG. 11 is a typical front view showing a variant example of the gas cell according to the second embodiment.

### BEST EMBODIMENTS FOR IMPLEMENTING THE INVENTION

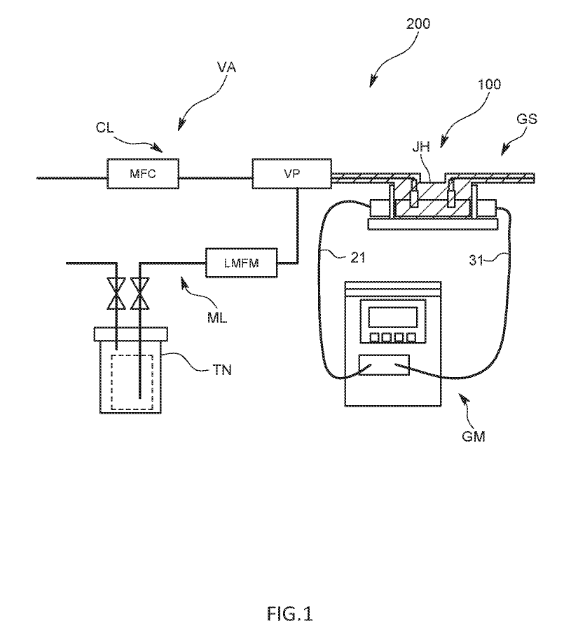

A gas concentration measurement apparatus 100 and a gas concentration control system 200 that employs this gas concentration measurement apparatus 100 according to a first embodiment of the present invention will now be described with reference made to FIG. 1 through FIG. 6.

The gas concentration control system 200 shown in FIG. 1 supplies H₂O₂, which is a material gas in, for example, a semiconductor manufacturing process, to an interior of a chamber that is used to form an oxide film on a substrate while maintaining this H₂O₂ at a constant concentration.

The gas concentration control system 200 generates H₂O₂ gas and is formed by a vaporization apparatus VA that controls the concentration of this H₂O₂ gas, and the gas concentration measurement apparatus 100 that is provided between the vaporization apparatus VA and a chamber and measures the concentration of the H₂O₂ gas passing therethrough. Note that if the H₂O₂ gas comes into contact with metal, then decomposition is generated in the H₂O₂ gas, which then forms H₂O and O₂. To prevent this, all of the gas-contacting portions of the gas concentration control system 200 are formed using a material other than metal.

As is shown in FIG. 1, the vaporization apparatus VA is provided with a carrier gas line CL on which is provided a mass flow controller MFC that controls the flow rate of N₂, which is a carrier gas, a material liquid line ML on which are provided a tank TN that internally contains an H₂O₂ solution and a liquid mass flow meter LMFM that measures the flow rate of the flowing H₂O₂ solution, and a vaporizer VP that is provided at a junction point of the carrier gas line CL and the material liquid line ML, and vaporizes the H₂O₂ solution by heating it. Note that the H₂O₂ solution is pressure-fed to the vaporizer VP by supplying N₂ gas at a predetermined pressure to an interior of the tank TN. Moreover, the mass flow controller MFC controls the flow rate of the carrier gas such that any discrepancy between the measured concentration of the H₂O₂ gas, as measured by the gas concentration measurement apparatus 100, and a target concentration is minimized.

As is shown in FIG. 1, the gas concentration measurement apparatus 100 is formed by a gas cell mechanism GS that is formed such that H₂O₂ gas, which is a sample gas, circulates through it and causes measurement light to be transmitted through this H₂O₂ gas, and a gas concentration monitor GM that causes measurement light to be generated and measures an absorbance of the measurement light that has been transmitted through the H₂O₂ gas in the gas cell mechanism GS.

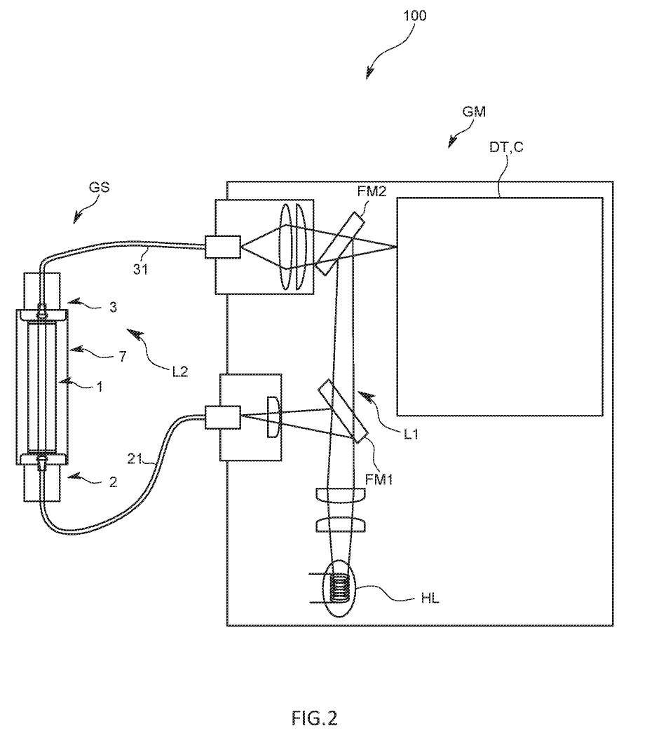

More specifically, as is shown in FIG. 2, the gas concentration measurement apparatus 100 measures the concentration of H₂O₂ gas based on an NIR method, and is provided with a reference light line L1 along which light whose wavelength is in a near infrared region and that has been emitted from a halogen light source HL is irradiated without passing through the gas cell mechanism GS onto a detector DT as reference light, and a measurement light line L2 along which light emitted from the halogen light source HL travels via the gas cell mechanism GS to the detector DT as measurement light. Moreover, this gas concentration measurement apparatus 100 is also provided with two switching mirrors, namely, a first switching mirror FM1 and a second switching mirror FM2 that are used to switch an optical path of the light emitted from the halogen light source HL to either the reference light line L1 or the measurement light line L2. Namely, when the light emitted from the halogen light source HL is to be made to arrive at the detector DT via the reference light line L1, the first switching mirror FM1 is removed from the optical path, and the second switching mirror FM2 is placed on the optical path. When the light emitted from the halogen light source HL is to be made to arrive at the detector DT via the measurement light line L2, the second switching mirror FM2 is removed from the optical path, and the first switching mirror FM1 is placed on the optical path.

In the detector DT, the absorbances in the absorption wavelength regions of H202 and H₂O are measured, for example, from the intensities of the reference light and the measurement light. The gas concentration monitor GM is further provided with a gas concentration calculator C that calculates the concentrations of the H₂O₂ gas and the H₂O gas based on the measured absorbances. The functions of the gas concentration calculator C are achieved as a result of a program stored in the memory of a computer, which is provided with a CPU, memory, input/output means, and an AC/DC converter and the like, being executed, and by each device working in mutual collaboration. Namely, the gas concentration calculator C is formed so as to calculate a gas concentration based on the absorbance and on a calibration curve showing a relationship between the absorbance and the gas concentration. The calibration curve is created in advance based on experiments and the like.

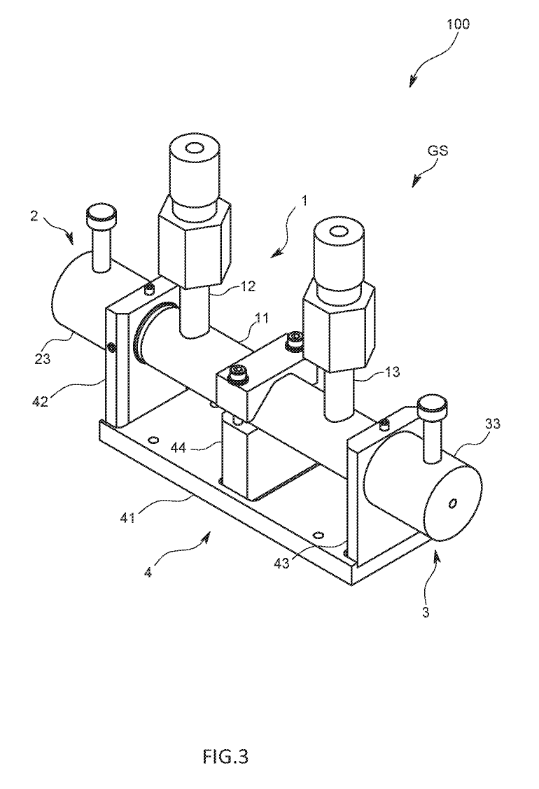

Next, the gas cell mechanism GS will be described in detail while referring to FIG. 3 through FIG. 6.

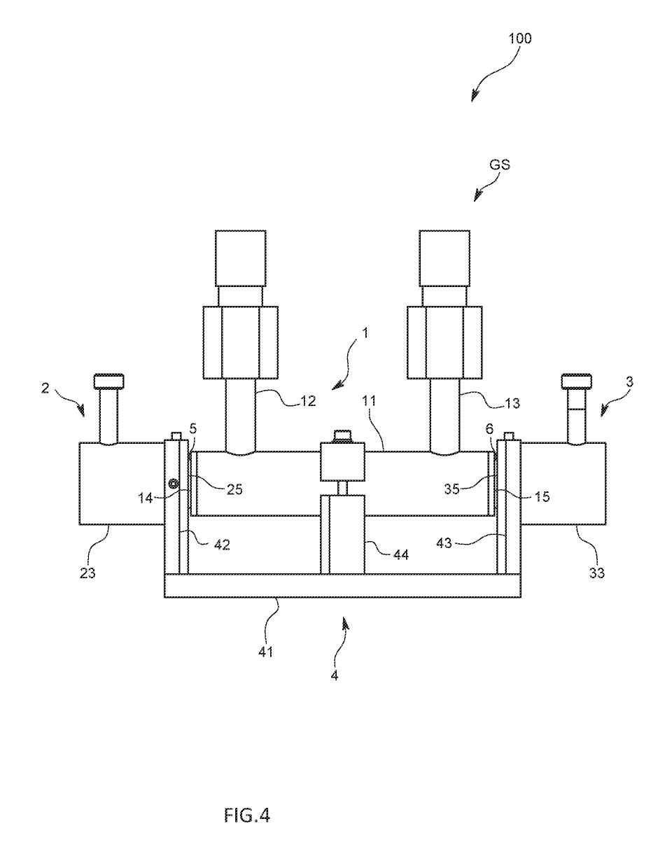

As is shown in FIG. 3 and FIG. 4, the gas cell mechanism GS forms a portion of a line that connects the vaporizer VP to the chamber, and is provided with a gas cell 1 into which H₂O₂ gas is introduced, a light-emitting unit 2 that causes measurement light to be irradiated into the gas cell 1, a light-receiving unit 3 that receives measurement light that has passed through the gas cell 1, and a fixing mechanism 4 that fixes the gas cell 1, the light-emitting unit 2, and the light-receiving unit 3 such that a predetermined positional relationship is maintained between these components. Optically speaking, the light-emitting unit 2 and the light-receiving unit 3 have the same component elements and, as is shown in a front view in FIG. 4, the gas cell mechanism GS can be disposed facing in either direction with the gas cell 1 located in the center. Moreover, in the present embodiment, the gas cell 1, the light-emitting unit 2, and the light-receiving unit 3 are each formed as mutually independent bodies.

The gas cell 1 is provided with a main body tube 11 having a circular cylinder-shaped configuration that is disposed between the light-emitting unit 2 and the light-receiving unit 3, a gas intake tube 12 that is provided extending perpendicularly from an upstream side of a side surface of the main body tube 11, and a gas discharge tube 13 that is provided on a downstream side of the side surface of the main body tube 11. The gas cell 1 is formed from quartz glass and does not cause any significant decomposition reaction in the H₂O₂ gas. An end surface on the upstream side of the main body tube 11 is formed as an incident surface 14 into which measurement light emitted from the light-emitting unit 2 is irradiated, while an end surface on the downstream side thereof is formed as an emission surface 15 from which measurement light that has passed through the H202 gas is emitted to the outside. Namely, the optical axis of the measurement light coincides with the axis of the main body tube 11.

As is shown in FIG. 1, in order to prevent vaporized H₂O₂ gas from cooling and becoming reliquefied, a jacket heater JH, which is a heater mechanism, is wrapped around the gas cell 1 so as to cover the periphery of the main body tube 11, and the peripheries of the gas intake tube 12 and the gas discharge tube 13. The jacket heater JH is provided with heating wires that are embedded in a belt-shaped resin material, which functions as an insulation material, and is wrapped such that it covers all side surfaces of each of the tubes. Note that the jacket heater JH is not in contact with the light-emitting unit 2 and the light-receiving unit 3, but is provided at a distance therefrom.

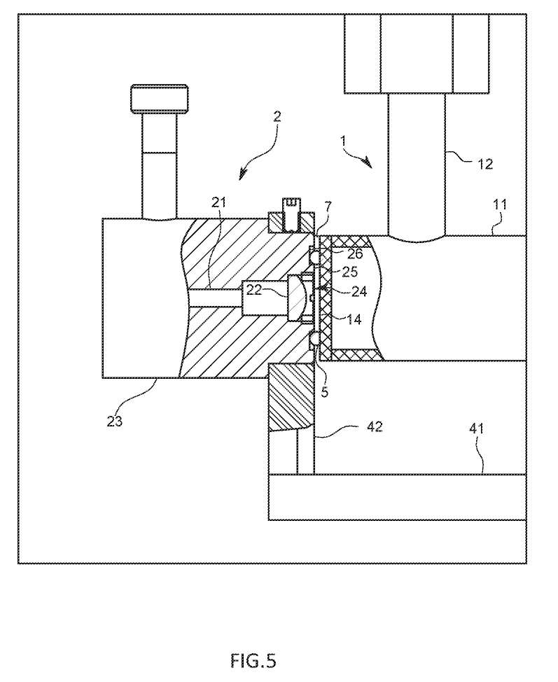

As is shown in FIG. 3, FIG. 4, and FIG. 5, the light-emitting unit 2 is provided with a first optical fiber 21 that guides measurement light emitted from the halogen light source HL, a first lens 22 that is provided so as to face an end surface of the first optical fiber 21, and a first holder 23 that is formed in a circular cylinder shape having substantially the same diameter as the main body tube 11, with the first optical fiber 21 and first lens 22 being held in an interior of the first holder 23.

The first holder 23 is made from resin, and an insertion hole that is used to insert the first optical fiber 21 inside the first holder 23 is opened in one end surface thereof, while an emission aperture 24 through which measurement light that has passed through the first lens 22 is emitted to the outside is formed adjacent to the light emission side of the first lens 22 in a first end surface 25, which is another end surface of the first holder 23. A first recessed groove 26 is formed in a circular shape centering on the emission aperture 24 in this first end surface 25. The first end surface 25 is provided in close proximity to and facing the incident surface 14 of the gas cell 1.

As is shown in FIG. 5, a first sealing component 5 in the form of an O-ring that is seated inside the first recessed groove 26 is provided between the first end surface 25 of the light-emitting unit 2 and the incident surface 14 of the gas cell 1. Namely, the first sealing component 5 is provided such that it encloses the periphery of the emission aperture 24 with an airtight seal. Moreover, when the light-emitting unit 2 and the gas cell 1 are fixed to the fixing mechanism 4, and the first sealing component 5 has been compressed in the thickness direction thereof, a first gap 7 is formed between the first end surface 25 and the incident surface 14. In other words, in an assembled state, the light-emitting unit 2 is not in direct contact with the gas cell 1, and heat from the gas cell 1 can only be conducted thereto indirectly via the first sealing component 5.

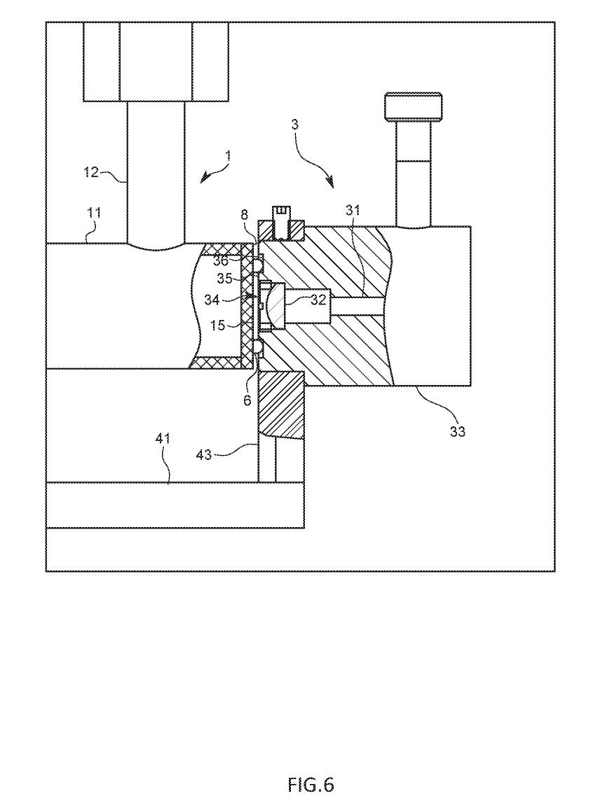

As is shown in FIG. 3, FIG. 4, and FIG. 6, the light-receiving unit 3 is provided with a second lens 32 that condenses the measurement light that has been transmitted through the gas cell 1, a second optical fiber 31 that is provided such that an end surface thereof faces the second lens 32 and guides measurement light that has passed through the second lens 32 to the detector DT, and a second holder 33 that is formed in a circular cylinder shape having substantially the same diameter as the main body tube 11, with the second lens 32 and second optical fiber 31 being held in an interior of the second holder 33.

The second holder 33 is made from resin, and an incident aperture 34 through which measurement light that has passed through the gas cell 1 is irradiated into the interior of the second holder 33 is formed adjacent to the light incident side of the second lens 32 in a second end surface 35, which is one end surface of the second holder 33, while an insertion hole that is used to insert the second optical fiber 31 inside the second holder 33 is opened in another end surface thereof. A second recessed groove 36 is formed in a circular shape centering on the incident aperture 34 in this second end surface 35. The second end surface 35 is provided in close proximity to and facing the emission surface 15 of the gas cell 1.

As is shown in FIG. 6, a second sealing component 6 in the form of an O-ring that is seated inside the second recessed groove 36 is provided between the emission surface 15 of the gas cell 1 and the second surface of the light-receiving unit 3. Namely, the second sealing component 6 is provided such that it encloses the periphery of the incident aperture 34 with an airtight seal. Moreover, when the gas cell 1 and the light-receiving unit 3 are fixed to the fixing mechanism 4, and the second sealing component 6 has been compressed in the thickness direction thereof, a second gap 8 is formed between the emission surface 15 and the second end surface 35. In other words, in an assembled state, the light-receiving unit 3 is not in direct contact with the gas cell 1, and heat from the gas cell 1 can only be conducted thereto indirectly via the second sealing component 6. Moreover, the first gap 7 and the second gap 8 are formed having substantially the same size, and the thickness dimensions of the first sealing component 5 and the second sealing component 6 prior to their deformation are larger than the first gap 7 and the second gap 8.

The fixing mechanism 4 is provided with a metal base 41 having an elongated plate-shaped configuration, and a first supporting pedestal 42, a second supporting pedestal 43, and a central supporting pedestal 44 that are made from resin and are provided standing upright on the base 41.

The first supporting pedestal 42 is a plate-shaped member that is provided standing upright from one end side of the base 41, and the light-emitting unit 2 is fixed thereto. More specifically, as is shown in FIG. 5, the first end surface 25 side of the first holder 23 is formed in a stepped circular cylinder shape, and a small diameter portion thereof, which is on the first end surface 25 side, is inserted into the first supporting pedestal 42. An end surface of the large diameter portion of the first holder 23 forms a reference surface, and a structure is employed in which, when this reference surface is abutted against one surface of the first supporting pedestal 42, the first end surface 25 and another surface of the first supporting pedestal 42 are substantially flush with each other. In this state, the light-emitting unit 2 is fixed in place by an anchoring screw on a side surface-side of the first holder 23, so that the position of the first end surface 25 is anchored.

The second supporting pedestal 43 is a plate-shaped member that is provided standing upright from another end side of the base 41, and the light-receiving unit 3 is fixed thereto. More specifically, as is shown in FIG. 6, the second end surface 35 side of the second holder 33 is formed in a stepped circular cylinder shape, and a small diameter portion thereof, which is on the second end surface 35 side, is inserted into the second supporting pedestal 43. An end surface of the large diameter portion of the second holder 33 forms a reference surface, and a structure is employed in which, when this reference surface is abutted against another surface of the second supporting pedestal 43, the second end surface 35 and one surface of the second supporting pedestal 43 are substantially flush with each other. In this state, the light-receiving unit 3 is fixed in place by an anchoring screw on a side surface-side of the second holder 33, so that the position of the second end surface 35 is anchored.

In this manner, simply as a result of the first holder 23 and the second holder 33 being fixed to the fixing mechanism 4, the first end surface 25 and the second end surface 35 can be accurately placed a predetermined distance apart from each other. Accordingly, the first optical fiber 21, the first lens 22, the second lens 32, and the second optical fiber 31 can also be placed in their proper positions on the optical axis in accordance with the design.

The central supporting pedestal 44 is a temporary holding mechanism on which the main body tube 11 of the gas cell 1 is temporarily held such that the main body tube 11 is able to slide in the direction of the optical axis of the measurement light. For example, when the first holder 23 is fixed to the fixing mechanism 4, the gas cell 1 is inserted through the central supporting pedestal 44, and the gas cell 1 is then pressed toward the first supporting pedestal 42 side while the first sealing component 5 is sandwiched between the first end surface 25 and the incident surface 14. Next, while the second sealing component 6 is sandwiched between the emission surface 15 and the second end surface 35, the gas cell 1 is pressed towards the first supporting pedestal 42 side as a result of the second holder 33 being fixed to the second supporting pedestal 43. By mounting the gas cell 1 in this manner, the gas cell 1 receives repulsive force from both the first sealing component 5 and the second sealing component 6 in their mutually opposite directions. As a result, the gas cell 1 is moved to a position where the respective forces are balanced relative to each other. Accordingly, the gas cell 1 moves naturally until it is disposed in the center between the first end surface 25 and the second end surface 35 and, in this state, the gas cell 1 is fixed by a screw relative to the central supporting pedestal 44. Namely, using the fixing mechanism 4 and the temporary holding mechanism, irrespective of the fact that the gas cell 1, the light-emitting unit 2, and the light-receiving unit 3 are all formed from mutually independent bodies, the gas cell 1 is held between the light-emitting unit 2 and the light-receiving unit 3 by pressure from the repulsive force from the first sealing component 5 and the second sealing component 6, and the optical components belonging to each unit can be precisely placed in their proper positions in accordance with the design.

According to the gas concentration measurement apparatus 100 having the above-described structure, because the first sealing component 5 and the second sealing component 6 are provided such that they enclose the emission aperture 24 and the incident aperture 34 respectively with an airtight seal, it is possible to prevent air from the environment surrounding the gas cell mechanism GS from penetrating the emission aperture 24 and the incident aperture 34. Moreover, even if a portion of the resin forming the insulation material is vaporized by heat emitted by the jacket heater JH, this vaporized gas can be prevented from penetrating the emission aperture 24 and the incident aperture 34.

Accordingly, it is possible to prevent constituents other than H₂O₂, which is a sample gas, from penetrating the optical path of the measurement light, and prevent air from the surrounding environment or gas from forming condensation on the first lens 22 or the second lens 32 so as to cause the measured light absorbance to change and thereby make it impossible to accurately measure the gas concentration.

Moreover, because the light-emitting unit 2 and the light-receiving unit 3 are not in direct contact with the gas cell 1, which is heated by the jacket heater, but only are only in contact with the gas cell 1 indirectly via the resin O-rings, it is possible to prevent the first optical fiber 21 and the second optical fiber 31 being heated by thermal conduction from the gas cell 1, and consequently causing a temperature change to occur. Accordingly, it is possible to keep the light-guiding characteristics of the optical fibers constant, and maintain a high level of measurement accuracy when measuring a gas concentration.

A variant example of the first embodiment will now be described.

In the above-described first embodiment, the gas concentration measurement apparatus of the present invention is used to measure the concentration of H₂O₂ gas, however, it is also possible to use this gas concentration measurement apparatus to measure the concentrations of other types of gases. For example, this gas concentration measurement apparatus may also be used to measure gas concentrations when creating a gas for medical applications, in order to obtain gas having a desired concentration. In the case of a gas that does not react with metal, which is not the case with H₂O₂ gas, the gas cell may be formed from a material other than quartz glass. Moreover, the light-emitting unit and the light-receiving unit may also be formed from a material other than resin.

The first sealing component and the second sealing component are not limited to being O-rings, and may also be formed from caulking material that is provided so as to fill the gaps between, for example, the gas cell and the light-emitting unit or the light-receiving unit. Moreover, resin may be used to form the O-rings, or alternatively, metal may be used. In addition, the heater mechanism is not limited to being a jacket heater, and some other heater mechanism may be used provided that it is able to heat the gas cell, does not cause a sample gas circulating inside it to decompose, and can be heated to a desired level without this heating causing it to reliquefy.

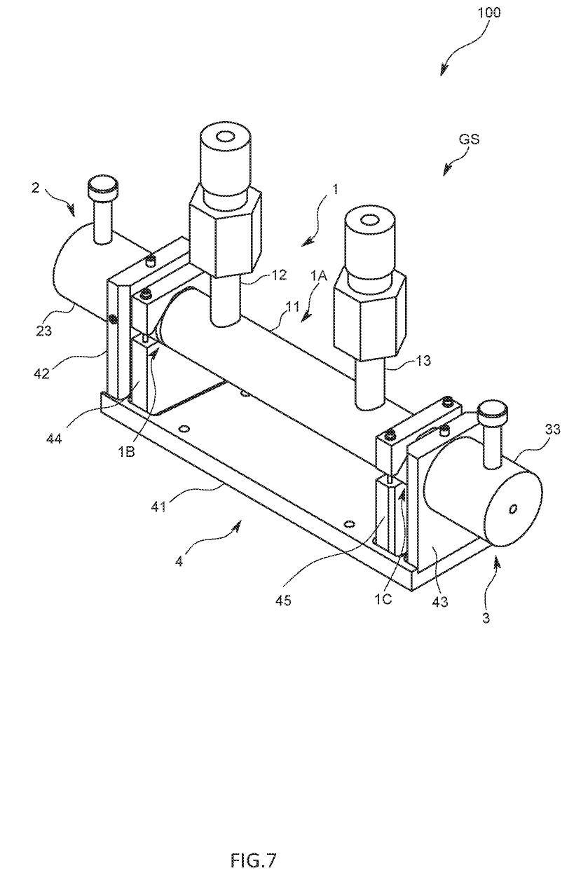

A gas concentration measurement apparatus 100 and a gas concentration control system 200 that employs this gas concentration measurement apparatus 100 according to a second embodiment of the present invention will now be described with reference made to FIG. 7 through FIG. 10. Note that the structure of the gas concentration measurement apparatus 100 according to the second embodiment differs from that of the first embodiment, while the structure of the gas concentration control system 200 is the same as that shown in FIG. 1 and FIG. 2.

Next, the gas cell mechanism GS will be described in detail with reference made to FIG. 7 through FIG. 10.

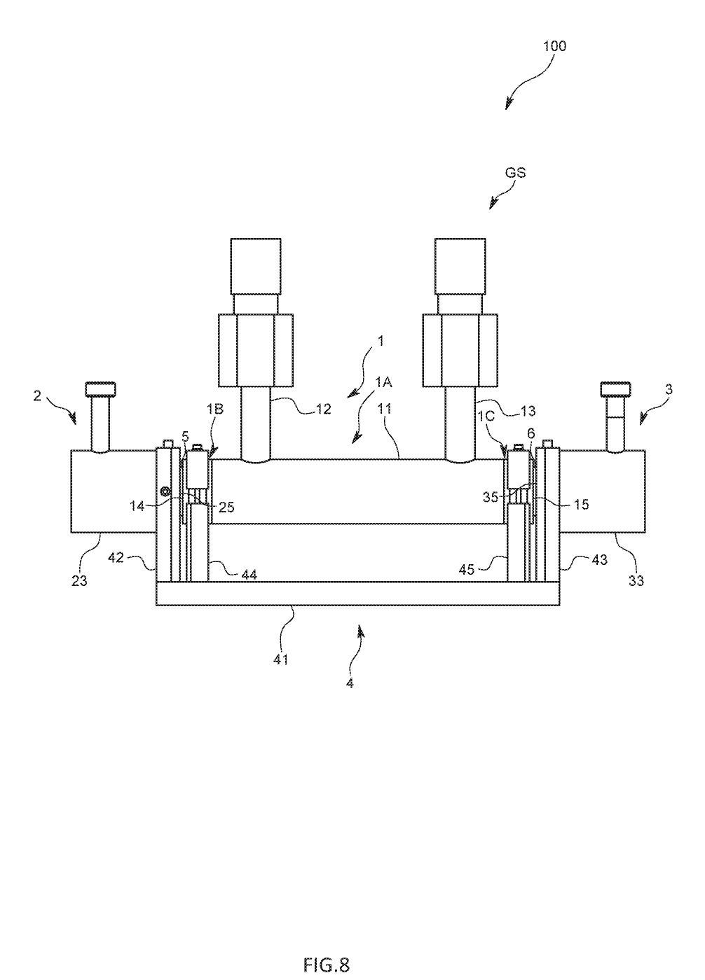

As is shown in FIG. 7 and FIG. 8, the gas cell mechanism GS forms a portion of a line that connects the vaporizer VP to the chamber, and is provided with a gas cell 1 into which H₂O₂ gas is introduced, a light-emitting unit 2 that causes measurement light to be irradiated into the gas cell 1, a light-receiving unit 3 that receives measurement light that has passed through the gas cell 1, and a fixing mechanism 4 that fixes the gas cell 1, the light-emitting unit 2, and the light-receiving unit 3 such that a predetermined positional relationship is maintained between these components. Optically speaking, the light-emitting unit 2 and the light-receiving unit 3 have the same component elements and, as is shown in a front view in FIG. 8, the gas cell mechanism GS can be disposed facing in either direction with the gas cell 1 located in the center. Moreover, in the present embodiment, the gas cell 1, the light-emitting unit 2, and the light-receiving unit 3 are each formed as mutually independent bodies.

The gas cell 1 is provided with a cell main body 1A into the interior of which the sample gas is introduced, an incident portion 1B through which measurement light is irradiated into the interior of the cell main body 1A, and an emission portion 1C through which measurement light that has passed through the cell main body 1A is emitted to the outside. The gas cell 11 is formed by a plurality of quartz glass pieces and this makes it difficult for a decomposition reaction to occur in the H₂O₂ gas. Moreover, the gas cell 1 is supported by the fixing mechanism 4 (described below) at both ends thereof at the portions where the incident portion 1B and the emission portion 1C are located.

The cell main body 1A is provided with a main body tube 11 having a circular cylinder-shaped configuration that is disposed between the light-emitting unit 2 and the light-receiving unit 3, a gas intake tube 12 that is provided extending perpendicularly from an upstream side of a side surface of the main body tube 11, and a gas discharge tube 13 that is provided on a downstream side of the side surface of the main body tube 11.

The incident portion 1B and the emission portion 1C each have a double-glazed window structure D whose interior is maintained in a vacuum. In the present embodiment, a circular cylinder-shaped tube having two closed ends that each have the same diameter is bonded via an optical contact bond to the main body tube 11 which has two open ends and has a circular cylinder-shaped configuration.

Note that optical contact bonding refers to a method in which pieces of smoothened glass can be bonded together simply by being placed in contact with each other without any adhesive agent being used, and refers to glass that is bonded, for example, at room temperature or at high temperature. In an optical contact bond, two pieces of glass are strongly bonded together by the Van der Waals force between the two glass surfaces or by hydrogen bonding between silanol groups that are formed by the absorption of moisture from the air. Namely, in the gas cell 1, flat surfaces of a plurality of quartz glass pieces can be placed in direct contact with each other and bonded together without having to dissolve the glass using an adhesive agent or chemical agent. Because of this, no changes in the optical characteristics are brought about by the adhesive agent or by the dissolution of the glass, while the vacuum inside the double-glazed window structure D is maintained, and the dimensional tolerance and strength of the gas cell 1 are kept the same as those of the independent cell main body 1A by itself prior to the bonding.

As is shown in FIG. 7 through FIG. 10, the incident portion 1B, the main body tube 11, and the emission portion 1C are provided extending in a row in this sequence so as to form a single circular cylinder-shaped tube in which the optical axis of the measurement light is made to coincide with the axis of the main body tube 11. Moreover, an end surface on the outer side of the incident portion B is formed as the incident surface 14 into which measurement light emitted from the light-emitting unit 2 is initially irradiated. In contrast, an end surface on the outer side of the emission portion 1C, which is on the downstream side of the gas cell 1, is formed as the emission surface 15 from which measurement light that has passed through the H₂O₂ gas is finally transmitted.

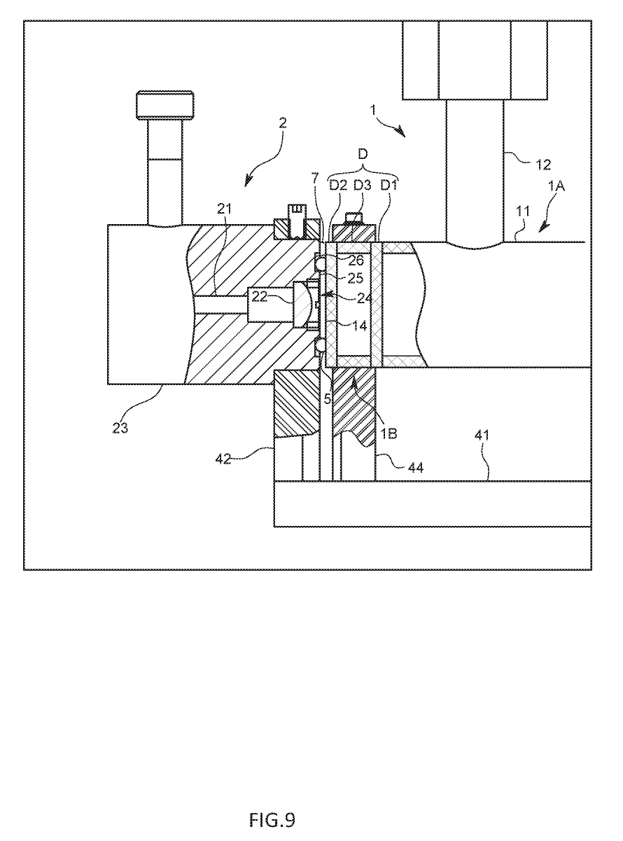

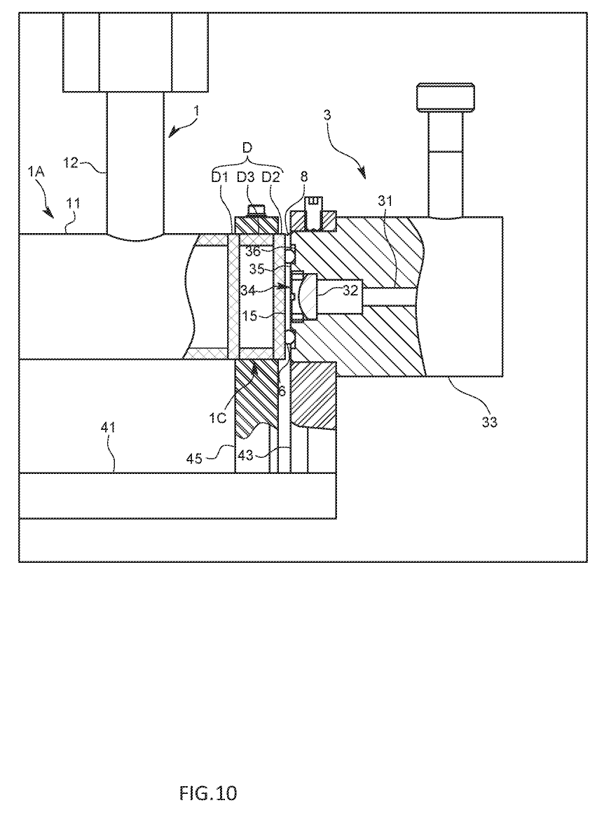

As is shown in FIG. 9 and FIG. 10, the double-glazed window structure D is provided with a circular plate-shaped inner window plate D1 that is bonded via an optical contact bond to the cell main body 1A, a circular plate-shaped outer window plate D2 that is provided in parallel with and a predetermined distance away from the inner window plate D1, and a circular cylinder-shaped enclosing wall D3 whose two ends are both open, and that joins together the inner window plate D1 and the outer window plate D2 such that a closed space is formed inside the enclosing wall D3. Each of the inner window plate D1, the outer window plate D2, and the enclosing wall D3 are bonded together by optical contact.

As is shown in FIG. 1, in order to prevent vaporized H₂O₂ gas from cooling and becoming reliquefied, a jacket heater JH, which is a heater mechanism, is wrapped around the gas cell 1 so as to cover the periphery of the main body tube 11, and the peripheries of the gas intake tube 12 and the gas discharge tube 13. The jacket heater JH is provided with heating wires that are embedded in a belt-shaped resin material, which functions as an insulation material, and is wrapped such that it covers all side surfaces of each of the tubes. Note that, in the present embodiment, because the gas cell 1 is supported at both ends thereof at the portions where the incident portion 1B and the emission portion 1C are located, but is not supported at the portion of the cell main body 1A, which is wrapped with the jacket heater JH, the jacket heater JH can be wrapped uniformly around the main body tube 11 so that a uniform temperature distribution inside the gas cell 1 can be achieved easily. More specifically, the jacket heater JH is only provided at the portion where the main body tube 11 is located, and the portions where the incident portion 1B and the emission portion 1C are located are not covered. Namely, the jacket heater JH is not in direct contact with the light-emitting unit 2 and the light-receiving unit 3.

As is shown in FIG. 7, FIG. 8, and FIG. 9, the light-emitting unit 2 is provided with the first optical fiber 21 that guides measurement light emitted from the halogen light source HL, the first lens 22 that is provided so as to face an end surface of the first optical fiber 21, and the first holder 23 that is formed in a circular cylinder shape having substantially the same diameter as the main body tube 11, with the first optical fiber 21 and first lens 22 being held in an interior of the first holder 23.

The first holder 23 is made from resin, and an insertion hole that is used to insert the first optical fiber 21 inside the first holder 23 is opened in the one end surface thereof, while an emission aperture 24 through which measurement light that has passed through the first lens 22 is emitted to the outside is formed adjacent to the light emission side of the first lens 22 in the first end surface 25, which is the other end surface of the first holder 23. The first recessed groove 26 is formed in a circular shape centering on the emission aperture 24 in this first end surface 25. The first end surface 25 is provided in close proximity to and facing the incident surface 14 of the gas cell 1.

As is shown in FIG. 9, the first sealing component 5, which is in the form of an O-ring that is seated inside the first recessed groove 26, is provided between the first end surface 25 of the light-emitting unit 2 and the incident surface 14 of the gas cell 1. Namely, the first sealing component 5 is provided such that it encloses the periphery of the emission aperture 24 with an airtight seal. Moreover, when the light-emitting unit 2 and the gas cell 1 are fixed to the fixing mechanism 4, and the first sealing component 5 has been compressed in the thickness direction thereof, the first gap 7 is formed between the first end surface 25 and the incident surface 14. In other words, in an assembled state, the light-emitting unit 2 is not in direct contact with the gas cell 1.

As is shown in FIG. 7, FIG. 8, and FIG. 10, the light-receiving unit 3 is provided with the second lens 32 that condenses the measurement light that has been transmitted through the gas cell 1, the second optical fiber 31 that is provided such that an end surface thereof faces the second lens 32 and guides measurement light that has passed through the second lens 32 to the detector DT, and the second holder 33 that is formed in a circular cylinder shape having substantially the same diameter as the main body tube 11, with the second lens 32 and second optical fiber 31 being held in an interior of the second holder 33.

The second holder 33 is made from resin, and the incident aperture 34 through which measurement light that has passed through the gas cell 1 is irradiated into the interior of the second holder 33 is formed adjacent to the light incident side of the second lens 32 in the second end surface 35, which is the one end surface of the second holder 33, while the insertion hole that is used to insert the second optical fiber 31 inside the second holder 33 is opened in the other end surface thereof. The second recessed groove 36 is formed in a circular shape centering on the incident aperture 34 in this second end surface 35. The second end surface 35 is provided in close proximity to and facing the emission surface 15 of the gas cell 1.

As is shown in FIG. 10, the second sealing component 6, which is in the form of an O-ring that is seated inside the second recessed groove 36, is provided between the emission surface 15 of the gas cell 1 and the second surface of the light-receiving unit 3. Namely, the second sealing component 6 is provided such that it encloses the periphery of the incident aperture 34 with an airtight seal. Moreover, when the gas cell 1 and the light-receiving unit 3 are fixed to the fixing mechanism 4, and the second sealing component 6 has been compressed in the thickness direction thereof, the second gap 8 is formed between the emission surface 15 and the second surface 35. In other words, in an assembled state, the light-receiving unit 3 is not in direct contact with the gas cell 1.

Moreover, the first gap 7 and the second gap 8 are formed having substantially the same size, and the thickness dimensions of the first sealing component 5 and the second sealing component 6 prior to their deformation are larger than the first gap 7 and the second gap 8.

The fixing mechanism 4 is provided with the metal base 41 having an elongated plate-shaped configuration, and the first supporting pedestal 42, the second supporting pedestal 43, an incident portion supporting pedestal 44, and an emission portion supporting pedestal 45 that are made from resin and are provided standing upright on the base 41.

The first supporting pedestal 42 is a plate-shaped member that is provided standing upright from the one end side of the base 41, and the light-emitting unit 2 is fixed thereto. More specifically, as is shown in FIG. 9, the first end surface 25 side of the first holder 23 is formed in a stepped circular cylinder shape, and a small diameter portion thereof, which is on the first end surface 25 side, is inserted into the first supporting pedestal 42. An end surface of the large diameter portion of the first holder 23 forms a reference surface, and a structure is employed in which, when this reference surface is abutted against the one surface of the first supporting pedestal 42, the first end surface 25 and the other surface of the first supporting pedestal 42 are substantially flush with each other. In this state, the light-emitting unit 2 is fixed in place by an anchoring screw on a side surface-side of the first holder 23, so that the position of the first end surface 25 is anchored.

The second supporting pedestal 43 is a plate-shaped member that is provided standing upright from the other end side of the base 41, and the light-receiving unit 3 is fixed thereto. More specifically, as is shown in FIG. 10, the second end surface 35 side of the second holder 33 is formed in a stepped circular cylinder shape, and a small diameter portion thereof, which is on the second end surface 35 side, is inserted into the second supporting pedestal 43. An end surface of the large diameter portion of the second holder 33 forms a reference surface, and a structure is employed in which, when this reference surface is abutted against the other surface of the second supporting pedestal 43, the second end surface 35 and the one surface of the second supporting pedestal 43 are substantially flush with each other. In this state, the light-receiving unit 3 is fixed in place by an anchoring screw on a side surface-side of the second holder 33, so that the position of the second end surface 35 is anchored.

In this manner, simply as a result of the first holder 23 and the second holder 33 being fixed to the fixing mechanism 4, the first end surface 25 and the second end surface 35 can be accurately placed a predetermined distance apart from each other. Accordingly, the first optical fiber 21, the first lens 22, the second lens 32, and the second optical fiber 31 can also be placed in their proper positions on the optical axis in accordance with the design.

The incident portion supporting pedestal 44 and the emission portion supporting pedestal 45 are formed such that they are only in contact with the portions of the gas cell 1 where the double-glazed window structure D is formed. Namely, in the gas cell 1, the incident portion supporting pedestal 44 and the emission portion supporting pedestal 45 are in contact with the outer side circumferential surface of the enclosing wall D3 in the portions that are most resistant to a thermal effect from the jacket heater JH, which are also the portions where the temperature is most able to remain constant. Note that it is also possible for a portion of each of the incident portion supporting pedestal 44 and the emission portion supporting pedestal 45 to protrude from the incident portion 1B and the emission portion 1C in such a way that they also support a portion of the cell main body 1A.

According to the gas concentration measurement apparatus 100 that is formed in the above-described manner, because the incident portion 1B and the emission portion 1C, which are the both end portions of the gas cell 1 on the upstream and downstream sides thereof, have the double-glazed window structure D, heat from the jacket heater JH is insulated by the incident portion 1B and the emission portion 1C, and it is difficult for this heat to be conducted to the light-emitting unit 2 and the light-receiving unit 3. Because of this, even if a sample gas is sufficiently heated such that it does not become reliquefied inside the gas cell 1, it is possible to prevent the light-guiding characteristics of the respective optical fibers being changed by this heat, and causing a concomitant change in the accuracy of the concentration measurement.

Moreover, it is also difficult for the heat from the jacket heater JH to be conducted directly to the incident portion supporting pedestal 44 and the emission portion supporting pedestal 45, and the temperatures of each of these can easily be kept constant. Accordingly, in spite of the fact that both ends of the gas cell 1 are being supported, because it is difficult for thermal deformation to be generated independently in both the incident portion supporting pedestal 44 and the emission portion supporting pedestal 45, the attitude of the gas cell 1 can be maintained constantly at the same attitude. Because of this, even if heating of the sample gas does take place, the optical axis of the measurement light can be made to remain substantially the same as the optical axis of the gas cell 1, and any change in the optical characteristics thereof can be prevented. As a consequence, a high degree of concentration measurement accuracy can be maintained. Note that it is also possible for the first supporting pedestal 42 and the incident portion supporting pedestal 44, which are standing upright on the base 41, to be formed as a single body, and for the second supporting pedestal 43 and the emission portion supporting pedestal 45, which are standing upright on the base 41, to also be formed as a single body. Namely, a first engaging portion may be provided that positions both the light-emitting unit 2 and the incident portion 1B on one single base, and a second engaging portion may be provided that positions both the light-receiving unit 3 and the emission portion 1C on another single base. If this type of structure is employed, then simply by mounting the gas cell 1, the light-emitting unit 2, and the light-receiving unit 3 on a base, the optical axes of each can be made to coincide precisely, and the complexity of this task can be alleviated.

Furthermore, because the first sealing component 5 and the second sealing component 6 are provided so as to enclose the emission aperture 24 and the incident aperture 34 respectively with airtight seals, air from the environment surrounding the gas cell mechanism GS can be prevented from penetrating the emission aperture 24 and the incident aperture 34. Even if a portion of the resin forming the insulation material does become vaporized by the heat generated by the jacket heater JH, this vaporized gas can still be prevented from penetrating the emission aperture 24 and the incident aperture 34.

Accordingly, it is possible to prevent a measured absorbance being changed because of elements other than H₂O₂, which is a sample gas, penetrating the optical path of measured light, or because of gas or air from the surrounding environment causing the first lens 22 and the second lens 32 to become fogged, and thereby preventing the gas concentration from being measured accurately.

A variant example of the second embodiment will now be described.

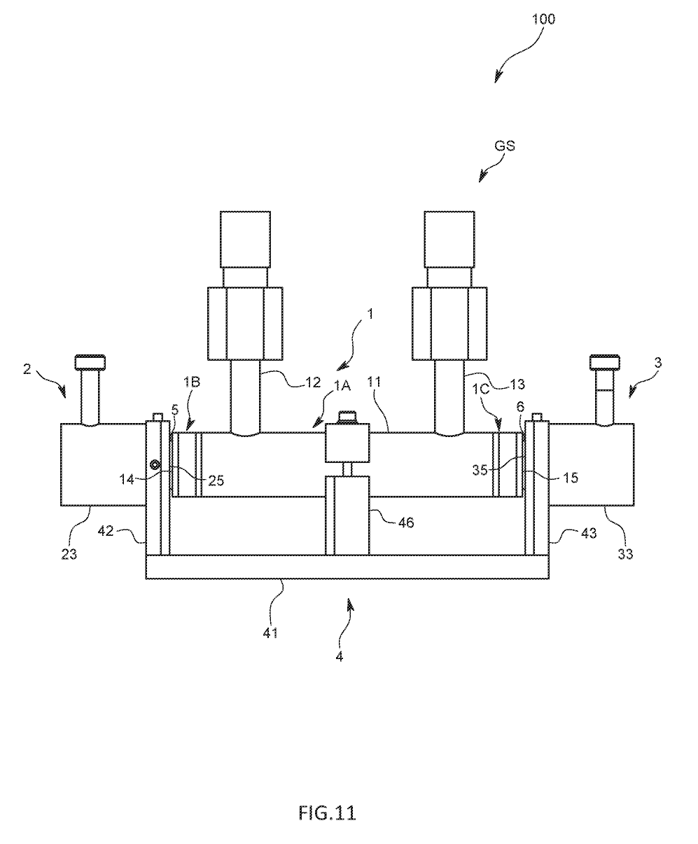

In the second embodiment a structure is employed in which the gas cell 1 is supported at both ends thereof by the incident portion 1B and the emission portion 1C being fixed by the incident portion fixing pedestal 44 and the emission portion fixing pedestal 45 of the fixing mechanism 4. However, as is shown in FIG. 11, it is also possible to provide a central portion supporting pedestal 46 that only provides support at one point, namely, in the central portion of the cell main body 1A of the gas cell 1.

If this type of structure is employed, then even if assembling errors or the like relative to the optical axis direction occur in the gas cell 1 so that the configuration from the incident portion 1B to the emission portion 1C differs from the design values, compared with when support is provided at the two ends, it is still easy to assemble the gas cell 1 in such a way that light can be transmitted from the light-emitting unit 2 to the light-receiving unit 3. Moreover, because the central portion of the gas cell 1 is supported at a single point, it is more difficult for a load to be generated by configuration errors than when support is provided at both ends, and an increased lifespan can be obtained from the finished product.

In the above-described second embodiment, the gas concentration measurement apparatus of the present invention is used to measure the concentration of H₂O₂ gas, however, it may also be used to measure concentrations of other types of gases. For example, this gas concentration measurement apparatus may also be used to measure gas concentrations when creating a gas for medical applications, in order to obtain gas having a desired concentration. In the case of a gas that does not react with metal, which is not the case with H₂O₂ gas, the gas cell may be formed from a material other than quartz glass. Moreover, the light-emitting unit and the light-receiving unit may also be formed from a material other than resin.

Moreover, the degree of vacuum inside the closed space of the double-glazed window structure may be set as is appropriate, and it is only necessary for this degree of vacuum to provide sufficient insulation to prevent any effects of the heat from the heater mechanism from appearing in the respective optical fibers. Moreover, it is also possible for the closed internal space inside the double-glazed window structure to not be set in a vacuum, but for this closed space to instead be filled with a gas. For example, the interior of this closed space may also be filled with a different type of gas from the sample gas, or with a gas having a different absorption wavelength from the sample gas. Specific examples include filling the closed space with gas in the form of dried air from which water vapor has been removed, or else causing this gas to circulate inside the closed space. If this type of structure is employed, then the gas inside the closed space functions as a translucent insulation material even if the closed space is not a vacuum, and prevents heat from the heater mechanism from being conveyed to the respective optical fibers. Furthermore, if dry air is used, then even though a gas is present inside the double-glazed window structure, there is no light absorption by H₂O, and it is possible to prevent this type of light absorption from causing any reduction in accuracy when measuring the concentration of, for example, H₂O₂ or another gas. Moreover, the interior of the closed space is not limited to being sealed completely airtight, and it is also possible for there to be an extremely slight gap such as might eventuate, for example, as the degree of vacuum deteriorates over time. Note that if a gas is present inside the double-glazed window structure, then this gas may be at the same pressure as the atmospheric pressure or may be depressurized to below atmospheric pressure.

Furthermore, the diameter of the double-glazed window structure may also be different from the diameter of the main body tube. Furthermore, it is also possible for the light-emitting unit and the light-receiving unit to be placed in direct contact respectively with the incident portion and the emission portion without a sealing component being interposed between them. In this type of structure as well, no thermal conduction to the light-emitting unit and the light-receiving unit is able to occur because of the insulation functions of the incident portion and the emission portion, and the temperature of the respective optical fibers can be kept constant.

The heater mechanism is not limited to a type of heater mechanism that directly heats the gas cell and it is also possible, for example, to heat the sample gas in a tube before the sample gas is introduced into the gas cell.

The first sealing component and the second sealing component are not limited to being O-rings, and it is also possible, for example for these sealing components to be in the form of caulking that is provided such that it fills the gaps between the light-emitting unit and the gas cell or the light-receiving unit and the gas cell. In addition, any O-ring may be formed from resin, or may be formed from metal. The heater mechanism is also not limited to being a jacket heater, and any type of heater that heats the gas cell, that does not decompose any sample gas internally circulating inside itself, and that can be heated sufficiently without becoming liquefied may be used.

Furthermore, it should be understood that the present invention is not limited to the above-described embodiments, and that various modifications and the like may be made thereto insofar as they do not depart from the spirit or scope of the present invention.

### DESCRIPTION OF THE REFERENCE NUMERALS

100 . . . Gas concentration measurement apparatus
1 . . . Gas cell
14 . . . Incident surface
15 . . . Emission surface
1A . . . Cell main body
1B . . . Incident portion
1C . . . Emission portion
2 . . . Light-emitting unit
21 . . . First optical fiber
22 . . . First lens
23 . . . First holder
24 . . . Emission aperture
25 . . . First end surface
3 . . . Light-receiving unit
31 . . . Second optical fiber
32 . . . Second lens
33 . . . Second holder
34 . . . Incident aperture
35 . . . Second end surface
4 . . . Fixing mechanism
5 . . . First sealing component
6 . . . Second sealing component

What is claimed is:

1. A gas concentration measurement apparatus comprising:
a gas cell equipped with an incident surface through which measurement light is irradiated into an interior of the gas cell, and an emission surface through which the measurement light is emitted to the outside of the gas cell, and that is formed such that a sample gas is introduced into the interior of the gas cell;
a heater mechanism that heats the gas cell;
a light-emitting unit that causes measurement light that has been emitted from an end surface of a first optical fiber provided inside the light-emitting unit to be emitted into the gas cell via an emission aperture;
a light-receiving unit that causes measurement light that has passed through the gas cell and is to be irradiated into an incident aperture to be irradiated onto an end surface of a second optical fiber provided inside the light-receiving unit;
a first sealing component that is provided between the incident surface of the gas cell and a first end surface that is formed at a periphery of the emission aperture of the light-emitting unit so as to enclose the periphery of the emission aperture; and
a second sealing component that is provided between the emission surface of the gas cell and a second end surface that is formed at a periphery of the incident aperture of the light-receiving unit so as to enclose the periphery of the incident aperture.

2. The gas concentration measurement apparatus according to claim 1, wherein the first sealing component and the second sealing component are O-rings.

3. The gas concentration measurement apparatus according to claim 1, wherein, in a state in which the first sealing component and the second sealing component have been provided,
a first gap is formed between the incident surface of the gas cell and the first end surface of the light-emitting unit, and
a second gap is formed between the emission surface of the gas cell and the second end surface of the light-receiving unit.

4. The gas concentration measurement apparatus according to claim 3, wherein the first gap and the second gap have substantially the same size, and a thickness dimension prior to deformation of each of the first sealing component and the second sealing component is set so as to be larger than the first gap and the second gap.

5. The gas concentration measurement apparatus according to claim 1, wherein
the gas cell is formed from quartz glass, and wherein
the light-emitting unit is provided with:
a first optical fiber via whose end surface measurement light is emitted;
a first lens that performs collimation on the measurement light emitted from the end surface of the first optical fiber; and
a first holder that is made from resin and inside which are held the first optical fiber and the first lens, with
an emission aperture and the first end surface being formed in the first holder, and wherein
the light-receiving unit is provided with:
a second optical fiber via whose end surface measurement light is introduced;
a second lens that condenses measurement light onto the end surface of the second optical fiber; and
a second holder that is made from resin and inside which are held the second optical fiber and the second lens, with
an incident aperture and the second end surface being formed in the second holder.

6. The gas concentration measurement apparatus according to claim 1, wherein the heater mechanism is a jacket heater that is wrapped around the periphery of the gas cell, and is provided so as to be separated from the first end surface and the second end surface.

7. The gas concentration measurement apparatus according to claim 1, wherein there are further provided:
a fixing mechanism that fixes the first end surface of the light-emitting unit and the second end surface of the light-receiving unit such that these are a predetermined distance apart from each other; and
a temporary holding mechanism that temporarily holds the gas cell such that the gas cell is able to slide in the direction of the optical axis of the measurement light, and
a structure is employed in which the gas cell is gripped between the light-emitting unit and the light-receiving unit by being pressed by repulsive force from the first sealing component and the second sealing component.

8. The gas concentration measurement apparatus according to claim 1, wherein the sample gas introduced into the gas cell contains H₂O₂, and
the measurement light contains light in a near infrared region, and
there is further provided a concentration calculator that calculates a concentration of the H₂O₂ gas introduced into the gas cell interior based on an absorbance of the measurement light received by the light-receiving unit.

9. A gas concentration measurement apparatus comprising:
a gas cell equipped with a cell main body into whose interior sample gas is introduced, an incident portion through which measurement light is irradiated into an interior of the cell main body, and an emission portion through which the measurement light that has passed through the cell main body is emitted to the outside;
a heater mechanism that heats the gas cell, or the sample gas introduced into the gas cell;
a first optical fiber that is provided so as to emit measurement light from an end surface thereof, and cause this measurement light to be irradiated into the incident portion; and
a second optical fiber that is provided such that the measurement light that has passed through the emission portion is irradiated onto an end surface of the second optical fiber, wherein
the incident portion and the emission portion have a double-glazed window structure whose interior is either maintained in a vacuum, or holds a gas.

10. The gas concentration measurement apparatus according to claim 9, wherein the double-glazed window structure comprises:
an inner window plate that is attached to the cell main body;
an outer window plate that is provided at a predetermined distance from the inner window plate so as to be parallel with the inner window plate; and
an enclosing wall that connects the inner window plate to the outer window plate so as to form a closed space, wherein
an interior of the closed space is either maintained in a vacuum, or holds a gas.

11. The gas concentration measurement apparatus according to claim 9, wherein the cell main body has an elongated shape, and
the incident portion and the emission portion are each joined to a mutually different end portion of the cell main body, and
there is further provided a supporting mechanism that supports one point of a central portion of the cell main body.

12. The gas concentration measurement apparatus according to claim 9, wherein the cell main body has an elongated shape, and
the incident portion and the emission portion are each joined to a mutually different end portion of the cell main body, and
there are further provided supporting mechanisms that support both ends of the gas cell at the incident portion and the emission portion.

13. The gas concentration measurement apparatus according to claim 9, wherein the heater mechanism is a jacket heater that is wrapped around the cell main body.

14. The gas concentration measurement apparatus according to claim 9, wherein
the gas cell is formed from a plurality of quartz glass pieces, and
the incident portion and the emission portion are bonded via optical contact bonding to the cell main body.

15. The gas concentration measurement apparatus according to claim 9, wherein there are further provided:
a light-emitting unit that causes measurement light that has been emitted from an end surface of the first optical fiber provided inside the light-emitting unit to be emitted into the gas cell via an emission aperture;
a light-receiving unit that causes measurement light that has passed through the gas cell and is to be irradiated into an incident aperture to be irradiated onto an end surface of a second optical fiber provided inside the light-receiving unit;
a first sealing component that is provided between an incident surface, which is a surface on the incident portion that measurement light first strikes from an outer side, and a first end surface that is formed at a periphery of the emission aperture of the light-emitting unit, so as to enclose the periphery of the emission aperture; and
a second sealing component that is provided between an emission surface, which is a surface on the emission portion that measurement light is ultimately emitted from, and a second end surface that is formed at a periphery of the incident aperture of the light-receiving unit, so as to enclose the periphery of the incident aperture.

16. The gas concentration measurement apparatus according to claim 9, wherein the sample gas introduced into the gas cell contains H₂O₂, and
the measurement light contains light in a near infrared region, and
there is further provided a concentration calculator that calculates a concentration of the H₂O₂ gas introduced into the gas cell interior based on an absorbance of the measurement light received by the light-receiving unit.
